(19) United States
(12) Patent Application Publication
(10) Pub. No.: US 2013/0179254 A1
(43) Pub. Date: Jul. 11, 2013

(54) USING USER EXPRESSIONS OF INTEREST TO DEEPEN USER RELATIONSHIP

(71) Applicants: David Joa, San Bruno, CA (US); Debashis Ghosh, Charlotte, NC (US); Thomas Mann, Charlotte, NC (US)

(72) Inventors: David Joa, San Bruno, CA (US); Debashis Ghosh, Charlotte, NC (US); Thomas Mann, Charlotte, NC (US)

(73) Assignee: Bank of America Corporation, Charlotte, NC (US)

(21) Appl. No.: 13/346,679

(22) Filed: Jan. 9, 2012

(51) Int. Cl. G06Q 30/02

(52) U.S. Cl. 705/14.49

(57) ABSTRACT

Embodiments of the invention are directed to collecting one or more expressions of interest from a user, where the one or more expressions of interest indicating potential interest in one or more financial products or financial services. Then, using a processing device, an interest index is calculated based at least in part on the collected one or more expressions of interest from the user. The interest index is configured to quantify a level of interest expressed by the user for one or more financial products or financial services. Next, based at least in part on the interest index, a level of engagement for deepening a relationship with the user is determined. Finally, one or more offline marketing efforts for deepening the relationship with the user are initiated based on the determined level of engagement.

### FIELD

In general, embodiments of the invention relate to methods, systems and computer program products for deepening a user relationship with a financial institution. More specifically, embodiments of the invention relate to methods, systems and computer program products for using user expressions of interest to deepen user relationships with a financial institution.

### BACKGROUND

Typically, customers of financial institutions interact with the financial institutions in a variety of ways. In recent history, many of those interactions occur via an online environment, such as via a website or application running on a computing device such as a computer or mobile communications device. In some instances, users navigate to a webpage or other information presentation, such as in an application, related to one or more financial institution products or services. In some cases, the navigation is performed after the user has logged onto, for example, an online banking website. In such instances, the financial institution may have access to information identifying the user as a customer and/or potential customer. However, in some instances, the user exits the online banking website or other application before having an opportunity to fully appreciate the details of a product or service.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention address the above needs and/or achieve other advantages by providing, systems, methods and computer program products. According to embodiments of the invention, a method includes collecting one or more expressions of interest from a user, the one or more expressions of interest indicating potential interest in one or more financial products or financial services, calculating, using a processing device, an interest index based at least in part on the collected one or more expressions of interest from the user, the interest index configured to quantify a level of interest expressed by the user for one or more financial products or financial services, determining, based at least in part on the interest index, a level of engagement for deepening a relationship with the user, and initiating one or more offline marketing efforts for deepening the relationship with the user based on the determined level of engagement.

In some embodiments, collecting one or more expressions of interest from a user comprises collecting one or more expressions of interest expressed by the user across one or more online banking channels. In some embodiments, collecting one or more expressions of interest from a user comprises collecting one or more expressions of interest from a user using one or more offline banking channels.

In some embodiments, collecting one or more expressions of interest from a user comprises collecting one or more first expressions of interest related to a first product or service and collecting one or more second expressions of interest related to a second product or service. In some of these embodiments, calculating the interest index is based on the collected one or more first expressions of interest and the one or more second expressions of interest.

In some embodiments, calculating the interest index based on the collected one or more expressions of interest from the user comprises determining whether a relationship exists between two or more of the expressions of interest and setting the interest index at a higher level when a relationship exists between two or more of the expressions of interest than it would be set if no relationship existed between two or more of the expressions of interest. In some embodiments, initiating one or more offline marketing efforts for deepening the relationship with the user comprises initiating a direct mailing or email presenting the user with one or more offers for products or services not currently used by the user. In some embodiments, initiating one or more offline marketing efforts for deepening the relationship with the user comprises initiating a telephone call to the user for presenting the user with one or more offers for products or services not currently used by the user. In some embodiments, initiating one or more offline marketing efforts for deepening the relationship with the user comprises initiating a direct mailing or email presenting the user with one or more offers for modification to one or more products or services currently used by the user. In some embodiments, initiating one or more offline marketing efforts for deepening the relationship with the user comprises initiating a telephone call to the user for presenting the user with one or more offers for modification to one or more products or services currently used by the user.

In some embodiments, the method also includes retrieving user interaction data corresponding to the user. In these embodiments, calculating the interest index is based at least in part on the collected one or more expressions of interest from the user and some or all the retrieved interaction data. In some such embodiments, the user interaction data comprises user transaction data retrieved from one or more financial institution systems. In other such embodiments, the user interaction data comprises online chat data retrieved from one or more financial institution systems. In other such embodiments, the user interaction data comprises customer service line data comprising inbound voice recognition data or customer service representative data from one or more financial institution systems. In other such embodiments, the user interaction data comprises automated teller machine advertisement response data retrieved from one or more financial institution systems. In other such embodiments, the user interaction data comprises aged referral data, mobile marketing data, sign off splash data, or targeted advertisement data retrieved from one or more financial institution systems. In other such embodiments, calculating the interest index comprises determining whether the retrieved interaction data is related to the one or more expressions of interest, determining a rating for the retrieved interaction data, the rating being representative of user feedback regarding the one or more financial products or financial services or one or more related financial products or services, and, if the retrieved interaction data is related to the one or more expressions of interest, calculating the interest index based at least in part on the determined rating.

According to embodiments of the invention, a system has a processing device configured to receive one or more expressions of interest from a user, the one or more expressions of interest indicating potential interest in one or more financial products or financial services, calculate an interest index based at least in part on the collected one or more expressions of interest from the user, the interest index configured to quantify a level of interest expressed by the user for one or more financial products or financial services, and initiate one or more offline marketing efforts for deepening the relationship with the user based on a determined level of engagement. In some such embodiments, the processing device is further configured to receive one or more expressions of interest expressed by the user across one or more online banking channels. In other such embodiments, the processing device is further configured to receive one or more expressions of interest from a user using one or more offline banking channels.

In other such embodiments, the processing device is further configured to receive one or more first expressions of interest related to a first product or service and receive one or more second expressions of interest related to a second product or service. In some of these embodiments, the processing device is further configured to calculate the interest index based on the received one or more first expressions of interest and the one or more second expressions of interest.

In some embodiments, the processing device is further to determine whether a relationship exists between two or more of the expressions of interest; and set the interest index at a higher level when a relationship exists between two or more of the expressions of interest than it would be set if no relationship existed between two or more of the expressions of interest. In some embodiments, the processing device is further configured to initiate a direct mailing or email presenting the user with one or more offers for products or services not currently used by the user. In some embodiments, the processing device is further configured to initiate a telephone call to the user for presenting the user with one or more offers for products or services not currently used by the user. In some embodiments, the processing device is further configured to initiate a direct mailing or email presenting the user with one or more offers for modification to one or more products or services currently used by the user. In some embodiments, the processing device is further configured to initiate a telephone call to the user for presenting the user with one or more offers for modification to one or more products or services currently used by the user.

In some embodiments, the processing device is further configured to retrieve user interaction data corresponding to the user and calculate the interest index is based at least in part on the collected one or more expressions of interest from the user and some or all the retrieved interaction data. In some such embodiments, the user interaction data comprises user transaction data retrieved from one or more financial institution systems. In other such embodiments, the user interaction data comprises online chat data retrieved from one or more financial institution systems. In other such embodiments, the user interaction data comprises customer service line data comprising inbound voice recognition data or customer service representative data from one or more financial institution systems. In other such embodiments, the user interaction data comprises automated teller machine advertisement response data retrieved from one or more financial institution systems. In other such embodiments, the user interaction data comprises aged referral data, mobile marketing data, sign off splash data, or targeted advertisement data retrieved from one or more financial institution systems. In other such embodiments, the processing device is further configured to determine whether the retrieved interaction data is related to the one or more expressions of interest, determine a rating for the retrieved interaction data, the rating being representative of user feedback regarding the one or more financial products or financial services or one or more related financial products or services, and, if the retrieved interaction data is related to the one or more expressions of interest, calculate the interest index based at least in part on the determined rating.

According to embodiments of the invention, a computer program product has a non-transient computer-readable medium with computer-executable instructions comprising instructions for receiving one or more expressions of interest from a user, where the one or more expressions of interest indicating potential interest in one or more financial products or financial services. The instructions also include instructions for calculating an interest index based at least in part on the collected one or more expressions of interest from the user. The interest index is configured to quantify a level of interest expressed by the user for one or more financial products or financial services. The instructions also include instructions for initiating one or more offline marketing efforts for deepening the relationship with the user based on a determined level of engagement.

In some embodiments, the instructions also include instructions for receiving one or more expressions of interest expressed by the user across one or more online banking channels. In some embodiments, the instructions also include instructions for receiving one or more expressions of interest from a user using one or more offline banking channels. In some embodiments, the instructions also include instructions for receiving one or more first expressions of interest related to a first product or service and receiving one or more second expressions of interest related to a second product or service. In some embodiments, the instructions also include instructions for calculating the interest index based on the received one or more first expressions of interest and the one or more second expressions of interest. In some embodiments, the instructions further comprise instructions for determining whether a relationship exists between two or more of the expressions of interest and setting the interest index at a higher level when a relationship exists between two or more of the expressions of interest than it would be set if no relationship existed between two or more of the expressions of interest. In some embodiments, the instructions also include instructions for initiating a direct mailing or email presenting the user with one or more offers for products or services not currently used by the user. In some embodiments, the instructions also include instructions for initiating a telephone call to the user for presenting the user with one or more offers for products or services not currently used by the user. In some embodiments, the instructions also include instructions for initiating a direct mailing or email presenting the user with one or more offers for modification to one or more products or services currently used by the user. In some embodiments, the instructions also include instructions for initiating a telephone call to the user for presenting the user with one or more offers for modification to one or more products or services currently used by the user.

In some embodiments, the instructions also include instructions for retrieving user interaction data corresponding to the user and calculating the interest index is based at least in part on the collected one or more expressions of interest from the user and some or all the retrieved interaction data. In some such embodiments, the user interaction data comprises user transaction data retrieved from one or more financial institution systems. In other such embodiments, the user interaction data comprises online chat data retrieved from one or more financial institution systems. In other such embodiments, the user interaction data comprises customer service line data comprising inbound voice recognition data or customer service representative data from one or more financial institution systems. In other such embodiments, the user interaction data comprises automated teller machine advertisement response data retrieved from one or more financial institution systems. In other such embodiments, the user interaction data comprises aged referral data, mobile marketing data, sign off splash data, or targeted advertisement data retrieved from one or more financial institution systems. In other such embodiments, the instructions further comprise instructions for determining whether the retrieved interaction data is related to the one or more expressions of interest, determining a rating for the retrieved interaction data, the rating being representative of user feedback regarding the one or more financial products or financial services or one or more related financial products or services, and, if the retrieved interaction data is related to the one or more expressions of interest, calculating the interest index based at least in part on the determined rating.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, wherein:

FIG. 1 is a flowchart illustrating a method 100 for using user expressions of interest to deepen a relationship between a user and a financial institution;

FIG. 2 is a flowchart illustrating a method 200 for calculating the interest index using expressions of interest related to different products;

FIG. 3 is a flowchart illustrating a method 300 for initiating offline marketing;

FIG. 4 is a flowchart illustrating a method 400 for calculating the interest index using a rating for user interaction data; and

FIG. 5 is a block diagram illustrating an environment 500 wherein a financial institution system 501 and various methods of this disclosure operate according to embodiments of the invention.

### DETAILED DESCRIPTION OF EMBODIMENTS OF THE INVENTION

This application is filed concurrently with related application having Ser. No. ______ and titled “Building and Using an Intelligent Logical Model of Effectiveness of Marketing Actions”, which is incorporated by reference herein in its entirety and assigned to the assignee of this application.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Embodiments of the invention are directed to collecting one or more expressions of interest from a user, where the one or more expressions of interest indicate potential interest in one or more financial products or financial services. Then, using a processing device, an interest index is calculated based at least in part on the collected one or more expressions of interest from the user. The interest index is configured to quantify a level of interest expressed by the user for one or more financial products or financial services. Next, based at least in part on the interest index, a level of engagement for deepening a relationship with the user is determined. Finally, one or more offline marketing efforts for deepening the relationship with the user are initiated based on the determined level of engagement. As used herein, the term “product(s)” is intended to include both financial institution products and/or financial institution services.

A “user” may refer to any person or persons and may be or include one or more “customers”, which generally implies a relationship between the person or persons and another entity, such as a financial institution. A user may be or include a person and one or more other members of the person's household, such as a spouse or child. For example, a user may refer to a husband and a wife who have established a joint account at a financial institution. Thus, the term user may refer to one or both the husband and/or the wife in the context of, for example, separately or jointly conducting transactions using the joint account. An example directed to some embodiments of the invention regards a situation where “user” interest, that is, household expressions of interest or expressions of interest of one or more members of a household, are collected in order to gauge the total interest of the household, which may be considered the user in this example. Then, responses to the expressions of interest may be tailored accordingly.

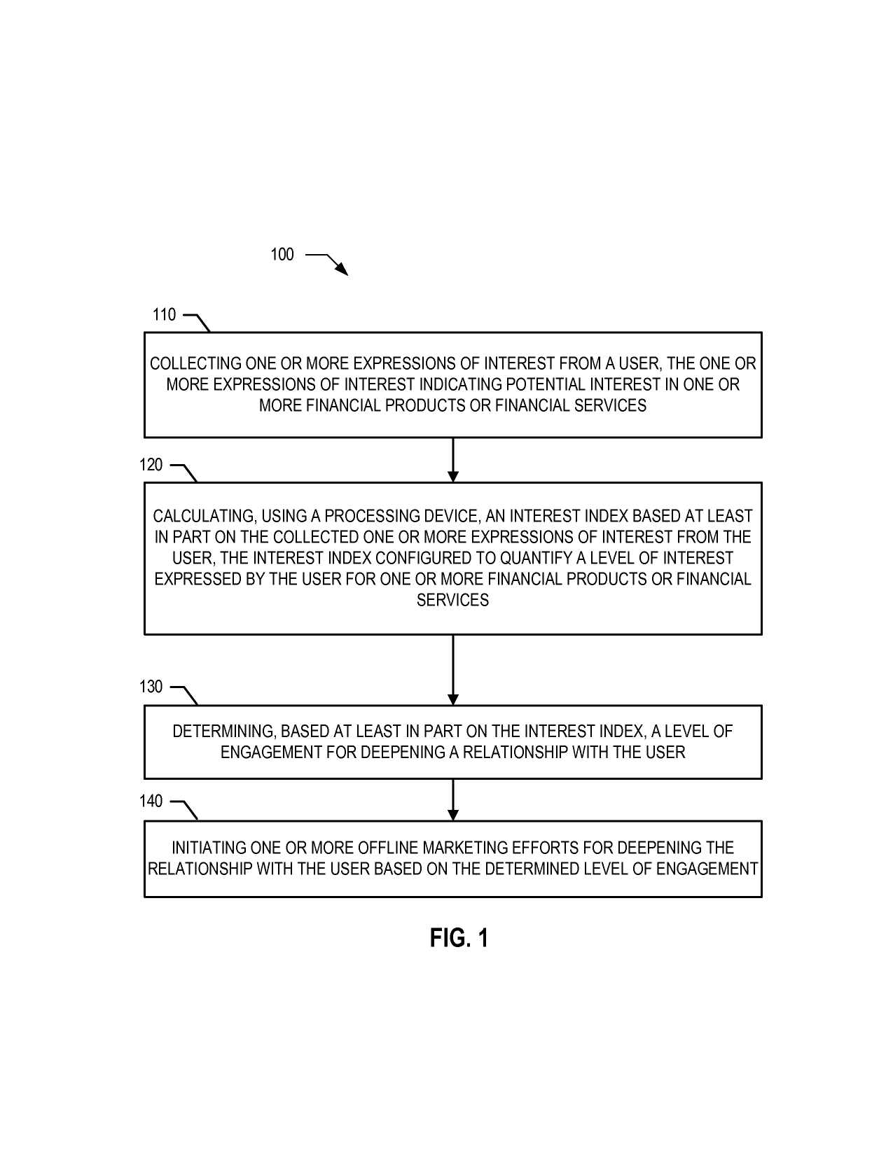

Referring now to FIG. 1, a flowchart illustrates a method 100 for using user expressions of interest to deepen a relationship between a user and a financial institution. Deepening of the relationship between the user and the financial institution may refer to creating a previously non-existent relationship or may refer to furthering a pre-existing relationship. The first step, as represented by block 110 is collecting one or more expressions of interest from a user. The expressions of interest typically indicate potential interest in one or more financial products and/or one or more financial services offered by the financial institution. An expression of interest may be generated by a user in a variety of ways, through online and/or offline channels. As discussed further below, a user's expression of interest may be positive or negative and may fall somewhere on a spectrum of user interest from strongly opposed to the product, moving through indifferent to the product, to strongly interested in the product. Also as discussed further below, a user may generate multiple expressions of interest that are determined to be related to one another and/or that may be determined to both/all be related to one or more products of the financial institution.

The user may be logged onto an online banking (OLB) website and may perform some action or inaction, which may be captured and used as an expression of interest in one or more products. The financial institution, because the user is logged into the OLB website, knows the identity of the user and can capture and associate user-generated expressions of interest with the user. For example, the user may select an advertisement or link regarding one or more products of the financial institution. Similarly, the user may perform calculations regarding existing account or potential accounts, such as using a mortgage calculator to calculate mortgage payments. Such an expression of interest may indicate that the customer is interested in a mortgage product. Other examples of OLB expressions of interest may include a user's response to a “splash-off” advertisement that appears to the user as the user is logging off from the OLB website or leaving a specific page or pages of the OLB website, a user's response to one or more advertisements targeted to the user while the user is logged on to the OLB website, a user's input beginning from the homepage of the financial institution website, such as where the user navigates from the homepage, input received from the user on one or more product pages, input received from the user on one or more application pages, and/or the like.

A user may also generate an expression of interest by searching inputs and responses to search results. For example, the user may perform a keyword search on the OLB website. As a more specific example, a user may search for “rewards”, “wire transfer”, “loans”, “order checks”, or the like, which may be an expression of interest for one or more products of the financial institution. As another specific example, a user may perform a search for “close account” or the like, thereby indicating an expression of interest, although the expression is negative. This expression of interest may be used, rather than to target a customer for a product, as an indicator that the customer may be about to close an account. Therefore, efforts can be taken to retain the user as a customer of the financial institution. As another example, the user may perform a natural search through an external search engine, thereby entering the financial institution's website and/or OLB website. As a specific example, a user may search for “Financial institution home equity loan” using a search engine external to the financial institution website, and once the user navigates to the financial institution website, that expression of interest may be captured.

As another example, a user may generate an expression of interest by responding to one or more mobile marketing tools, such as advertisements sent via text message, email, or the like. The user's response may include replying to a message or may include selecting a link referred to in the message or otherwise.

Another example of generating an expression of interest is an aged referral. An aged referral refers to a situation where, for example, a customer expresses an interest in a product, such as to a teller, but does not have time during their visit to discuss the product in detail. The teller may submit a referral to the financial institution system such that the user is referred to a personal banker or other associate of the financial institution. In some instances, the referral is not perfected by the associated and becomes “aged.” The financial institution system may access such information in determining an expression of interest as an input to the methods described herein.

As another example, a user may generate an expression of interest by responding to a teaser message during a call waiting experience, such as while waiting for a customer service representative during a phone call to a customer service center. Such response may include inputting numbers in a touch tone phone, may include voice input that may be recognized using voice recognition techniques, or may be some other type of response/input. This information may be stored by the financial institution systems and used as an input to the methods described herein.

As another example, a user may generate an expression of interest by responding to an automated teller machine (ATM) advertisement. Such an advertisement may be presented by the ATM to the user during a user transaction at the ATM machine, such as when the user is depositing funds using the ATM. For example, the ATM may present the user with a demand deposit account (DDA) product that would provide the user when a higher interest rate of return. The user may respond to this advertisement, and that response may be captured as an expression of interest.

Another example of a user expressing interest is during a chat or chatting session. The chat session may be incorporated into the user's online banking experience, such as a customer service representative of the financial institution chatting with the user to answer the user's question(s) regarding a product offered by the financial institution. Another example of a chatting session is a chat over a website or other media not maintained by the financial institution, such as a public chat or message board.

The next step of method 100, as represented by block 120, is calculating an interest index based at least in part on the collected one or more expressions of interest from the user. The interest index is configured to quantify a level of interest expressed by the user for one or more financial products and/or one or more financial services. The interest index is generally based on quantifying the user's expression of interest by correlating the expression of interest with a predetermined weighting or predetermined continuum of potential user interest. For example, if the user visits a mortgage product page on the financial institution's website, such an expression of interest may be weighted to indicate that the user showed an interest of 50 on a continuum of −100 to +100. In other embodiments, one or more of the expressions of interest may take on a variety of values rather than being simply binary values. In other words, one or more of the expressions of interest may be weighted based on factors such as, for example, the amount of time a user visits a particular page rather than simply that the user visited or did not visit a particular page.

In some embodiments, an original interest index is determined based on one or more initial expressions of interest and subsequent or other expressions of interest are considered and used to modify the interest index as appropriate based on the other expressions of interest. In this regard, the interest index may be somewhat of an average of a plurality of expressions of interest. In some embodiments, the expressions of interest may be weighted such that one expression of interest has a greater effect on the interest index than other expressions of interest. As a specific example, assume a user visits an OLB website hosted by the financial institution and visits a mortgage product page by navigating from the homepage of the website. Such a direct expression of interest, particularly if not spurred by some advertisement, may be considered a strong expression of interest. Therefore, that expression of interest may be used to set the interest index at 40 on a scale of −50 to +50.

In this example, the user may later perform an external word search for “mortgage at Financial Institution”, which directs the user to the Financial Institution website again. Such an expression of interest certainly may indicate that the user is interested in a mortgage product, but it may have less of an effect on the interest index than the first expression of interest. This is because the first expression of interest has already set the user's interest index relatively high on the scale of interest. Thus, the second expression of interest may be used to adjust the interest index to 45 on a scale of −50 to +50. If the user then expresses a negative expression of interest, perhaps through a different channel, the interest index may be adjusted down to account for the user's negative expression of interest. Thus, over a period of time, a user's interest may be gauged using the interest index and several expressions of interest of the user.

The next step, as represented by block 130, is determining a level of engagement for deepening, including in some instances creating, a relationship with the user. The determination, in some embodiments, is made based at least in part on the interest index. The level of engagement indicates the nature, quantity, urgency and the like associated with potential marketing efforts intended to capitalize on the one or more collected expressions of interest of the user, whether to initiate a relationship with a potential customer, deepen an existing relationship with an existing customer or prevent an existing customer from reducing or terminating an existing relationship.

The level of engagement may indicate, for example, that the user's expression(s) of interest are urgent and require a high level of communication, such as a personal telephone call from an associate to discuss the user's expression(s) of interest. The level of engagement, on the other hand, may indicate that the user's expression(s) of interest are not urgent and do not require a high level of communication. In such a situation an email to the user may be used to target the user with one or more offers related to the user's expression(s) of interest. In some embodiments, the level of engagement may indicate that the user should be contacted in multiple ways, such as via email as well as via standard mailing. In some embodiments, the level of engagement takes into account the user's preferences, such as preferences captured from the user via the OLB website.

In another example, the user may generate an expression of interest related to one product and another expression of interest related to another product. The financial institution system may determine that the products are related and, therefore, that the expressions of interest are related. Therefore, the level of engagement may be determined in order to propose multiple product options to the user. In another implementation, the level of engagement may be determined to propose the most relevant product to the user based on multiple expressions of interest, or in some embodiments, to present the most beneficial product option for the user.

The final step of FIG. 1, as represented by block 140, is initiating one or more offline marketing efforts for deepening the relationship with the user based on the determined level of engagement. As discussed above, the level of engagement generally indicates the type and quantity of marketing efforts for deepening the relationship with the user. Offline marketing efforts may include emails, direct mailings, personal contacts, such as in person contacts, telephone contacts, and the like. In addition to offline marketing efforts, online marketing efforts may be pursued as well. Thus, in some situations, the interest level is so high that the level of engagement is determined to be both repeated online and repeated offline marketing efforts. The one or more offline marketing efforts may be initiated automatically by the financial institution system, such as by preparing and sending an email message with a targeted offer for a product or some information regarding a product associated with a user's one or more expressions of interest. The one or more offline marketing efforts may also be initiated by the financial institution system printing a direct mailing and depositing it in the mailing queue. On the other hand, the offline marketing efforts may be initiated by the financial institution system initiating a communication or instruction to one or more associates to conduct an in-person contact and/or a live contact such as a telephone call or a video conference.

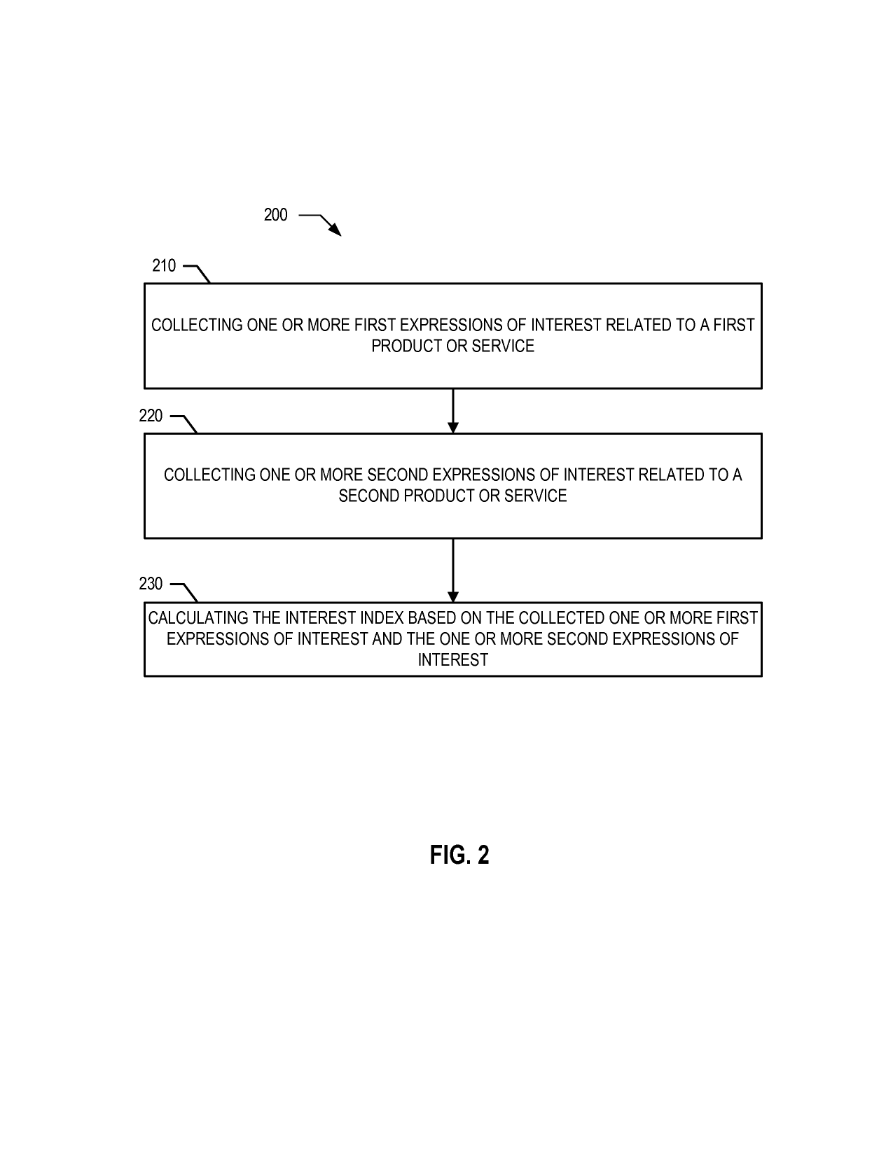

Referring now to FIG. 2, a flowchart illustrating a method 200 for calculating the interest index using expressions of interest related to different products is shown. The first step of the method 200, as represented by block 210, is collecting one or more first expressions of interest related to a first product or service, such as a first financial institution product or service. The next step, as represented by block 220 is collecting one or more second expressions of interest related to a second product or service, such as a second financial institution product or service.

The next step, as represented by block 230, is calculating the interest index based on the collected one or more first expressions of interest and the one or more second expressions of interest. In some instances, the user generates expressions of interest related to a first product or service that is different from the second product or service related other expressions of interest generated by the user, and in other instances, the first product or service and the second product or service are closely related or are the same. Thus, in some embodiments of the invention, the interest index is calculated by combining two or more expressions of interest that relate to different products and in some embodiments, the interest index is calculated by combining two or more expressions of interest that relate to the same or substantially the same product.

In some embodiments where the products or services are different, the expressions of interest may still be related, because the user may be expressing interest or lack of interest in the financial institution as a whole or may otherwise be expressing interest or lack of interest on a scale greater than simply with regard to a single product or service. Therefore, the financial institution system is configured to analyze the expressions of interest to determine whether an expression of interest that is not directly related to a product target nevertheless may indicate an interest, positive or negative, in that target product. This determination may be performed by analyzing whether the expression of interest unrelated to the target product relates to the financial institution as a whole. Also, the determination may be performed by analyzing whether the expression of interest, taken in combination with the expression of interest related to the target product, indicates interest, positive or negative, in one or more products that are related in some way with the target product. For example, a user may generate an expression of interest in a credit card account with a first expression of interest and may generate an expression of interest in a checking account with a second expression of interest. The expression of interest in the checking account may indicate further interest in the credit card account due to the fact that the user is expressing an interest in multiple products provided by the financial institution. Furthermore, the expression of interest in the checking account may further indicate interest in the credit card account due to the fact that the user is expressing an interest in products from the same category or class, which in this example is the category of banking products. Other examples of categories of financial institution products are mortgage and mortgage-related products, loans, financial planning, and so on.

As another example, a user may generate an expression of interest in a first product and generate another expression of interest in a second product that could be a replacement or alternative to the first product. In this example, the financial institution system may determine that the products function as alternatives to one another, and in this case, the user may be expressing an interest in only one or the other of the products rather than both of the products. In various embodiments, the interest index for the first product may be reduced based on the user generating an expression of interest in the second product or the interest index for the first product may be raised based on the fact that the user generated a negative expression of interest in the second product. In various other embodiments, the interest index for the second product may be reduced based on the user generating an expression of interest in the first product or the interest index for the second product may be raised based on the fact that the user generated a negative expression of interest in the first product.

Additionally, even if the user has not generated an expression of interest related to a particular product, an interest index for that product may be determined, calculated and/or set. For example, if the user generates an expression of interest in a product in a category of products, the user may have an interest in other products within the same category. In some instances, if the user generates an expression of interest for a first product that has an alternative product, then whether the expression of interest in the first product is positive or negative influences the user's interest in the alternative product. For example, if the user expresses a positive interest in a first product having an alternative product, then the interest index for the first product may be set above a median, such as 15 on a continuum of −25 to +25, whereas the interest index for the alternative product may also be set above the median because it would function as an alternative to the first product, but because the expression of interest was actually generated for the first product, the interest index for the first product is set higher than the interest index for the alternative product, which may be set, for example, at five on the continuum.

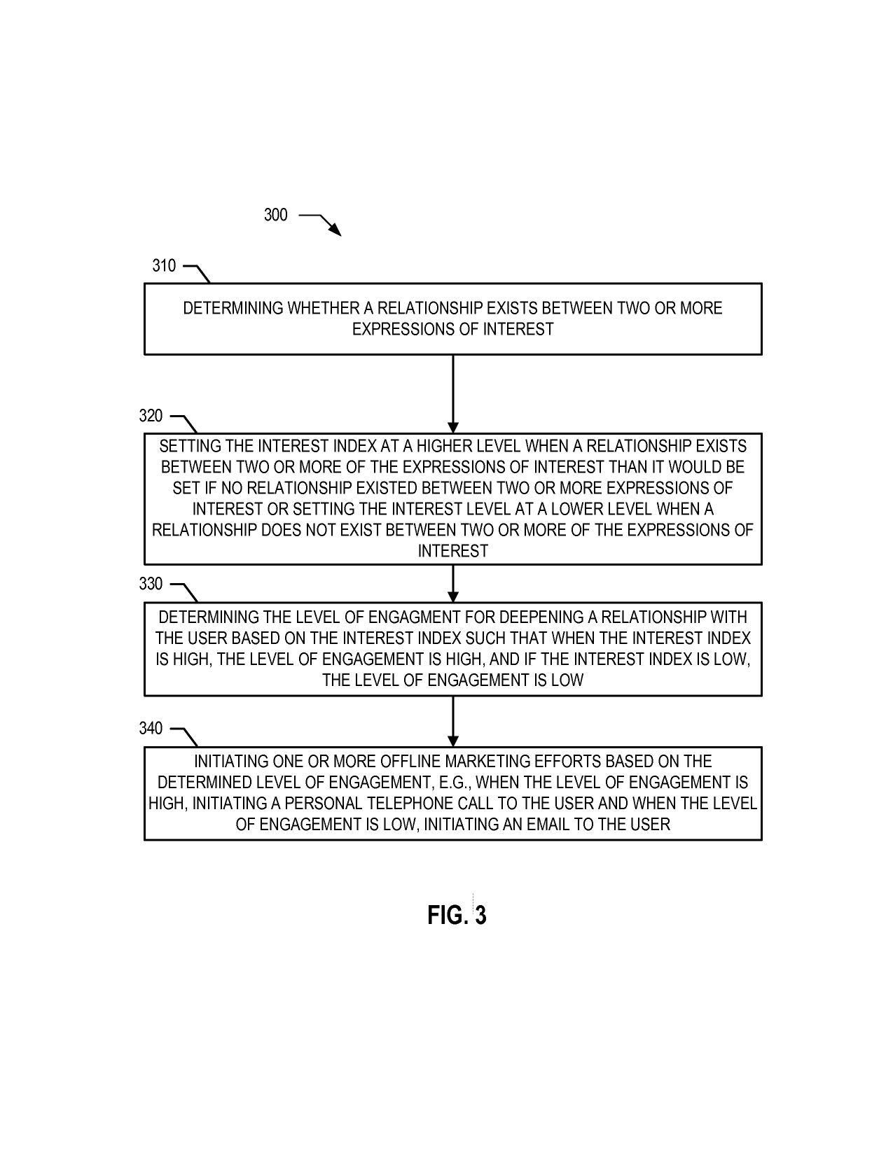

Referring now to FIG. 3, a flowchart illustrating a method 300 for initiating offline marketing efforts is shown. The first step, as represented by block 310, is determining whether a relationship exists between two or more expressions of interest. This determination may be made, such as by the financial institution system, as discussed above. For example, the determination may consider whether the two or more expressions of interest are related to products that are related in some way, such as being classified in the same category or such as being alternatives for one another.

The next step, as represented by block 320, is setting the interest index at a higher level when a relationship exists between two or more of the expressions of interest than it would be set if no relationship existed between two or more of the expressions of interest. Conversely, if no relationship existed between two or more of the expressions of interest, the interest index may be set at a lower level. This step is directed to a situation where, for example, a first expression of interest generated by a user and a second expression of interest generated by the user are both related to the same product or service. It should be noted, that step 320 assumes both the expressions of interest are positive expressions of interest, however, if one or both the expressions of interest are negative, then the interest index for the product is set at a lower level than it had previously been set, or if it had not previously been set, it is set at a level indicating a negative interest, such as below a threshold number or below a median on a range of index values, such as below 25 on a range from zero to 50.

The next step, as represented by block 330, is determining the level of engagement for deepening a relationship with the user based on the interest index such that when the interest index is high, the level of engagement is high, and if the interest index is low, the level of engagement is low. Thus, if multiple expressions of interest for a product are generated by a user, then the level of engagement may indicate a high quantity and type of offline and/or online marketing efforts for deepening the relationship with the user. For example, if two or more expressions of interest related to a product are positive, then the level of engagement quantity or frequency may be set to monthly and the type of engagement may be set to direct mailings. As another example, if two or more expressions of interest related to a product are overwhelmingly positive such that the interest index is calculated or set very high, then the frequency may be set to monthly and the type of engagement may be set to personal phone calls.

In another example, a frequency of engagement may be set and associated with a type of engagement and a second frequency of engagement may be set and associated with a second type of engagement. For example, a frequency of engagement may be set at every six months and associated with a type of engagement of personal phone call in addition to a second frequency of engagement being set at every month and associated with a type of engagement of an email. Thus, the level of engagement may indicate marketing efforts that may cross different channels, including offline channels and/or online channels with varying frequencies.

Finally, as represented by block 340, the final step is initiating one or more offline marketing efforts based on the determined level of engagement. For example, when the level of engagement includes a type of engagement that is high, a personal telephone call may be initiated to the user, whereas when the type of engagement is low, an email may be sent to the user. As discussed above, a frequency of engagement may also be set as part of the level of engagement and influence initiation of the one or more offline marketing efforts. In some embodiments, the initiation of the one or more offline marketing efforts may coincide with initiation of one or more online marketing efforts. In some embodiments, the initiation may include automatically initiating communication with the user, and in some embodiments, the initiation may include communicating with one or more associates responsible for communicating with the user as discussed above.

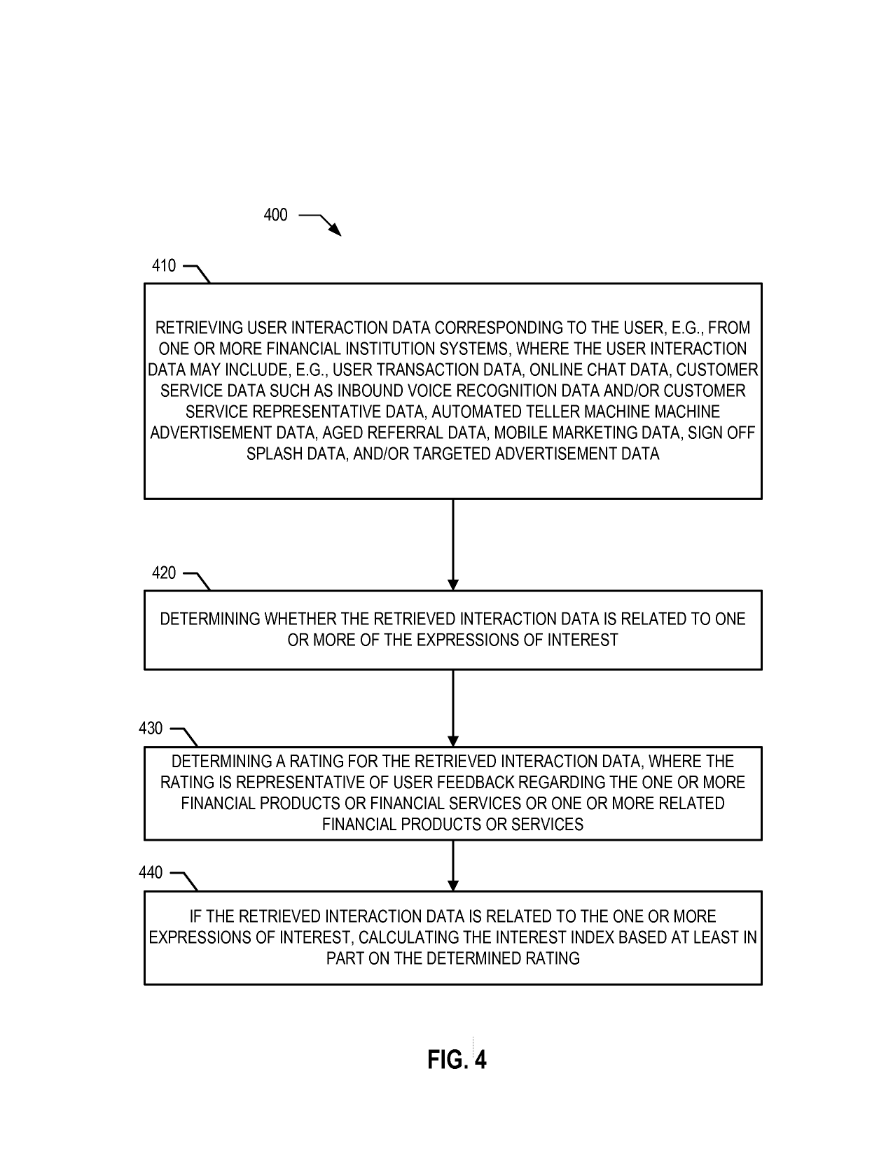

Referring now to FIG. 4, a flowchart illustrates a method 400 for calculating the interest index using a rating for user interaction data. The first step in the method 400, as represented by block 410 is retrieving user interaction data corresponding to the user, such as from one or more financial institution systems such as servers and/or databases. The user interaction data, in various embodiments, may include one or more of user transaction data, online chat data, customer service data such as inbound voice recognition data and/or customer service representative data, automated teller machine (ATM) advertisement data, aged referral data, mobile marketing data, sign-off splash data, and/or targeted advertisement data.

The next step, as represented by block 420, is determining whether the retrieved interaction data is related to one or more of the expressions of interest. In some embodiments of the financial institution system, the user interaction data by itself is used to calculate the interest index. In various other embodiments, a pre-existing interest index may be used in conjunction with the user interaction data to calculate a new interest index. In the method shown in FIG. 4, however, the user interaction data is used in combination with one or more expressions of interest to calculate the interest index.

The next step, as represented by block 430 is determining a rating for the retrieved interaction data, and the final step of FIG. 4, as represented by block 440, is calculating the interest index based at least in part on the determined rating if the retrieved interaction data is related to the one or more expressions of interest. In some embodiments, the rating is representative of user feedback regarding the one or more financial products or financial services and/or one or more related financial products or services. As discussed above, the expression of interest may be analyzed to determine the user's feedback rating for the product. For example, if the user uses certain words or phrases when discussing the product, then the financial institution system may set the user's rating of the product at a predetermined level. Further, if various words and/or phrases are used during discussing the product, then the system may combine ratings associated with those words and/or phrases to determine an overall user rating of the product. In various other embodiments, the financial institution system may determine the user rating of a product based on explicit user input regarding the product. For example, the user may indicate that the user rates the product as an eight out of ten. The system may then set a new interest index, reset a pre-existing interest index, or combine this information with one or more other expressions of interest to set a new interest index or reset a pre-existing interest index. Of course, once the interest index is calculated or set, other actions may be performed as discussed above, such as determining a level of engagement (for example, step 130) and/or initiating one or more offline and/or online marketing efforts for deepening the relationship with the user (for example, step 140).

In various embodiments, the financial institution system may also take into consideration expressions of interest of members of a user's network. For example, the financial institution may take into consideration expressions of interest of the user's family members when determining the interest index. As a specific example, if a member of the user's social network that is very close to the user, such as a spouse, generates an expression of interest in a mortgage product, then that expression of interest may be used to determine the user's interest index. In some embodiments, expressions of interest from individuals or entities other than the user may be discounted for not being the user, and in some embodiments, the expressions of interest from others may be weighted based on a degree of influence of the other person/entity on the user. For example, if the other person works in the same location at the same company and in the same line of business as the user, then expressions of interest from that person may carry less weight than expressions of interest from a distant acquaintance of the user, if such expressions of interest carry any weight at all.

In various embodiments, the interest index is affected by the closeness in time of one or more expressions of interest to the present. For example, a first expression of interest that occurred two years ago may be discounted in comparison to a second expression of interest that occurred two days ago. As a specific example, if a negative expression of interest occurred two years ago and a positive expression of interest, that is deemed as positive as the first expression of interest was negative, then the interest index will be set above median due to the fact that the newer positive expression of interest is more relevant than the older negative expression of interest.

In various embodiments, the interest index may be calculated or set based on analysis of one or more expressions of interest. Various factors may go into the calculation or setting of the interest index. For example, a number of pages viewed related to a particular product may be captured as part of the expression of interest and used in calculating the interest index. Further, some or all of frequency, amount of time since expression, page type (for example, tool page, application page, program page, marketing page and the like), time spent on page, entry type (for example, natural search, email, third party search and the like), keyword search, high value task, multiple channel activity as discussed above, and the like may be captured in conjunction with one or more expressions of interest and subsequently used in calculating and/or setting one or more interest indexes for one or more financial institution products and/or services.

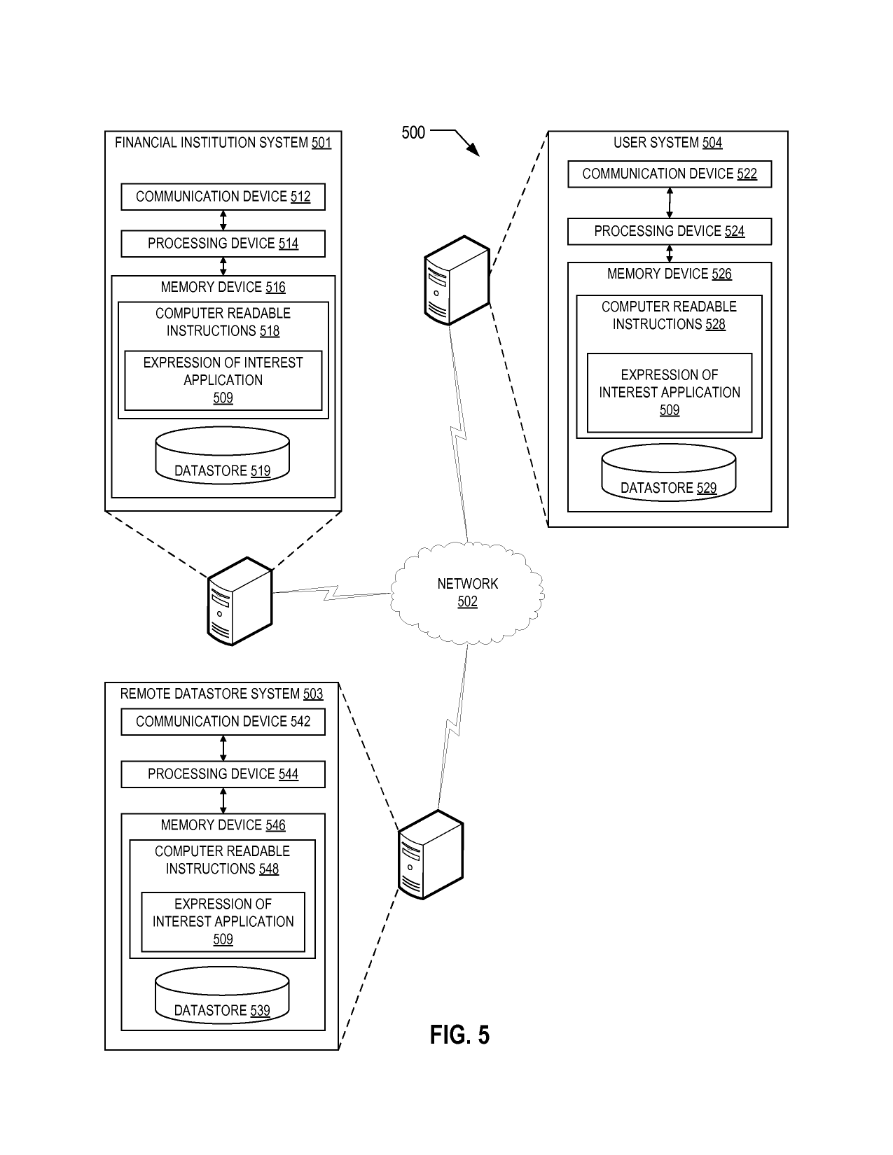

Referring now to FIG. 5, a block diagram illustrates an environment 500 wherein a financial institution system 501 and the various methods of the invention operate according to various embodiments. A financial institution system 501 is a computer system, server, multiple computer systems and/or servers or the like. The financial institution system 501, in the embodiments shown has a communication device 512 communicably coupled with a processing device 514, which is also communicably coupled with a memory device 516. The processing device is configured to control the communication device 512 such that the financial institution system 501 communicates across the network 502 with one or more other systems. The processing device 514 is also configured to access the memory device 516 in order to read the computer readable instructions 518, which in some embodiments includes an expression of interest application 509. The memory device 516 also has a datastore 519 or database for storing pieces of data for access by the processing device 514. For example, one or more user expressions of interest or data related thereto may be stored in datastore 519 soon after those expressions of interest occur, or in other embodiments, one or more expressions of interest may be stored remote to the financial institution system 501 and retrieved and/or collected by the financial institution system 501 as necessary to perform the methods described herein. Similarly, one or more types of user interaction data, for example, user transaction data, may be stored in datastore 519 and/or may be stored remote to financial institution system 501.

The expression of interest application 509 is configured for instructing the processing device 514 to perform various steps of the methods discussed herein, and/or other steps and/or similar steps. In various embodiments, the expression of interest application 509 is included in the computer readable instructions stored in a memory device of one or more systems other than the financial institution system 501. For example, in some embodiments, the financial institution application 509 is stored and configured for being accessed by a processing device of one or more other systems connected with the financial institution system 501 through network 502. In various embodiments, the expression of interest application 509 stored and executed by the financial institution system 501 is different from the expression of interest application 509 stored and executed by other systems, such as the user system 504. In some embodiments, the expression of interest applications stored and executed by different systems may be similar and may be configured to communicate with one another, and in some embodiments, the expression of interest applications 509 may be considered to be working together as a singular application despite being stored and executed on different systems.

In various embodiments, the interest index may be used for purposes other than only initiating marketing efforts. For example, the interest indexes and/or levels of engagement may be used to reduce the quantity and/or cost of online and/or offline channels of communication with users/customers. As a specific example, an analysis may be performed to determine what level of engagement is necessary to achieve positive results from the user/customer.

A user system 504 is configured for use by a user, for example, to access one or more financial institution applications such as one or more webpages and/or applications. The user system 504 may be or include a computer system, server, multiple computer system, multiple servers, a mobile device or some other computing device configured for use by a user, such as a desktop, laptop, tablet, or a mobile communications device, such as a smartphone. The user system 504 has a communication device 522 communicatively coupled with a processing device 524, which is also communicatively coupled with a memory device 526. The processing device 524 is configured to control the communication device 522 such that the user system 504 communicates across the network 502 with one or more other systems. The processing device 524 is also configured to access the memory device 526 in order to read the computer readable instructions 528, which in some embodiments include an expression of interest application 509. The memory device 526 also has a datastore 529 or database for storing pieces of data for access by the processing device 524.

The remote datastore system 503 is configured for providing one or more of the pieces of data used by the financial institution system 501, the user system 504 or some other system when running the expression of interest application 509 as discussed herein. In some embodiments, the remote datastore system 503 includes a communication device 542 communicatively coupled with a processing device 544, which is also communicatively coupled with a memory device 546. The processing device 534 is configured to control the communication device 542 such that the remote datastore system 503 communicates across the network 502 with one or more other systems. The processing device 544 is also configured to access the memory device 546 in order to read the computer readable instructions 548, which in some embodiments include instructions for communicating with the financial institution system 501, the user system 504 and/or one or more other systems, and in some embodiments, includes some or all of the expression of interest application 509. In some embodiments, the remote datastore system 503 includes one or more datastores 539 for storing and providing one or more pieces of data used by one or more other systems. In some such embodiments, the datastore 539 communicates directly with one or more other systems and receives instructions directly from one or more other systems, and in some embodiments, the datastore 539 receives instructions from the processing device 544, which may be based on the expression of interest application 509, running on one or more other systems and/or on the remote datastore system 503. Thus, in some embodiments, the remote datastore system 503 is considered a “active” device or system that interacts with one or more other systems actively to ensure the proper data is stored, retrieved, communicated, deleted, organized and so forth, whereas in other embodiments, the remote datastore system 503 is considered a “passive” device that receives instructions from an external source and performs tasks based on the instructions such as retrieving a requested piece of data and communicating it to the financial institution system 501.

In various embodiments, one of the systems discussed above, such as the financial institution system 501, is more than one system and the various components of the system are not collocated, and in various embodiments, there are multiple components performing the functions indicated herein as a single device. For example, in one embodiment, multiple processing devices perform the functions of the processing device 514 of the financial institution system 501 described herein. In various embodiments, the financial institution system 501 includes one or more of the user system 504, the remote datastore system 503, and/or any other system or component used in conjunction with or to perform any of the method steps discussed herein.

In various embodiments, the financial institution system 501, the user system 504, the remote datastore system 503 and/or other systems may perform all or part of a one or more method steps discussed above and/or other method steps in association with the method steps discussed above. Furthermore, some or all the systems discussed here, in association with other systems or without association with other systems, in association with steps being performed manually or without steps being performed manually, may perform one or more of the steps of method 100, method 200, method 300, and/or method 400.

In summary, embodiments of the invention are directed to collecting one or more expressions of interest from a user, where the one or more expressions of interest indicate potential interest in one or more financial products or financial services. Then, using a processing device, an interest index is calculated based at least in part on the collected one or more expressions of interest from the user. The interest index is configured to quantify a level of interest expressed by the user for one or more financial products or financial services. Next, based at least in part on the interest index, a level of engagement for deepening a relationship with the user is determined. Finally, one or more offline marketing efforts for deepening the relationship with the user are initiated based on the determined level of engagement.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon.

Computer-readable media is defined in greater detail herein below. It will be appreciated that, as with the processing device, each communication interface and memory device may be made up of a single device or many separate devices that conceptually may be thought of as a single device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor/processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A method comprising:
collecting one or more expressions of interest from a user, the one or more expressions of interest indicating potential interest in one or more financial products or financial services;
calculating, using a processing device, an interest index based at least in part on the collected one or more expressions of interest from the user, the interest index configured to quantify a level of interest expressed by the user for one or more financial products or financial services;
determining, based at least in part on the interest index, a level of engagement for deepening a relationship with the user; and
initiating one or more offline marketing efforts for deepening the relationship with the user based on the determined level of engagement.

2. The method of claim 1, wherein collecting one or more expressions of interest from a user comprises:
collecting one or more expressions of interest expressed by the user across one or more online banking channels.

3. The method of claim 1, wherein collecting one or more expressions of interest from a user comprises:
collecting one or more expressions of interest from a user using one or more offline banking channels.

4. The method of claim 1, wherein collecting one or more expressions of interest from a user comprises collecting one or more first expressions of interest related to a first product or service and collecting one or more second expressions of interest related to a second product or service.

5. The method of claim 4, wherein calculating the interest index is based on the collected one or more first expressions of interest and the one or more second expressions of interest.

6. The method of claim 1, wherein calculating the interest index based on the collected one or more expressions of interest from the user comprises:
determining whether a relationship exists between two or more of the expressions of interest; and
setting the interest index at a higher level when a relationship exists between two or more of the expressions of interest than it would be set if no relationship existed between two or more of the expressions of interest.

7. The method of claim 1, wherein initiating one or more offline marketing efforts for deepening the relationship with the user comprises:
initiating a direct mailing or email presenting the user with one or more offers for products or services not currently used by the user.

8. The method of claim 1, wherein initiating one or more offline marketing efforts for deepening the relationship with the user comprises:
initiating a telephone call to the user for presenting the user with one or more offers for products or services not currently used by the user.

9. The method of claim 1, wherein initiating one or more offline marketing efforts for deepening the relationship with the user comprises:
initiating a direct mailing or email presenting the user with one or more offers for modification to one or more products or services currently used by the user.

10. The method of claim 1, wherein initiating one or more offline marketing efforts for deepening the relationship with the user comprises:
initiating a telephone call to the user for presenting the user with one or more offers for modification to one or more products or services currently used by the user.

11. The method of claim 1, further comprising:
retrieving user interaction data corresponding to the user; and
wherein calculating the interest index is based at least in part on the collected one or more expressions of interest from the user and some or all the retrieved interaction data.

12. The method of claim 11, wherein the user interaction data comprises user transaction data retrieved from one or more financial institution systems.

13. The method of claim 11, wherein the user interaction data comprises online chat data retrieved from one or more financial institution systems.

14. The method of claim 11, wherein the user interaction data comprises customer service line data comprising inbound voice recognition data or customer service representative data from one or more financial institution systems.

15. The method of claim 11, wherein the user interaction data comprises automated teller machine advertisement response data retrieved from one or more financial institution systems.

16. The method of claim 11, wherein the user interaction data comprises aged referral data, mobile marketing data, sign off splash data, or targeted advertisement data retrieved from one or more financial institution systems.

17. The method of claim 11, wherein calculating the interest index comprises:
determining whether the retrieved interaction data is related to the one or more expressions of interest;
determining a rating for the retrieved interaction data, the rating being representative of user feedback regarding the one or more financial products or financial services or one or more related financial products or services; and
if the retrieved interaction data is related to the one or more expressions of interest, calculating the interest index based at least in part on the determined rating.

18. A system comprising a processing device configured to:
receive one or more expressions of interest from a user, the one or more expressions of interest indicating potential interest in one or more financial products or financial services;
calculate an interest index based at least in part on the collected one or more expressions of interest from the user, the interest index configured to quantify a level of interest expressed by the user for one or more financial products or financial services; and
initiate one or more offline marketing efforts for deepening the relationship with the user based on a determined level of engagement.

19. The system of claim 18, wherein the processing device is further configured to:
receive one or more expressions of interest expressed by the user across one or more online banking channels.

20. The system of claim 18, wherein the processing device is further configured to:
receive one or more expressions of interest from a user using one or more offline banking channels.

21. The system of claim 18, wherein the processing device is further configured to:
receive one or more first expressions of interest related to a first product or service; and
receive one or more second expressions of interest related to a second product or service.

22. The system of claim 21, wherein the processing device is further configured to:
calculate the interest index based on the received one or more first expressions of interest and the one or more second expressions of interest.

23. The system of claim 18, wherein the processing device is further to:
determine whether a relationship exists between two or more of the expressions of interest; and
set the interest index at a higher level when a relationship exists between two or more of the expressions of interest than it would be set if no relationship existed between two or more of the expressions of interest.

24. The system of claim 18, wherein the processing device is further configured to:
initiate a direct mailing or email presenting the user with one or more offers for products or services not currently used by the user.

25. The system of claim 18, wherein the processing device is further configured to:
initiate a telephone call to the user for presenting the user with one or more offers for products or services not currently used by the user.

26. The system of claim 18, wherein the processing device is further configured to:
initiate a direct mailing or email presenting the user with one or more offers for modification to one or more products or services currently used by the user.

27. The system of claim 18, wherein the processing device is further configured to:
initiate a telephone call to the user for presenting the user with one or more offers for modification to one or more products or services currently used by the user.

28. The system of claim 18, wherein the processing device is further configured to:
retrieve user interaction data corresponding to the user; and
calculate the interest index is based at least in part on the collected one or more expressions of interest from the user and some or all the retrieved interaction data.

29. The system of claim 28, wherein the user interaction data comprises user transaction data retrieved from one or more financial institution systems.

30. The system of claim 28, wherein the user interaction data comprises online chat data retrieved from one or more financial institution systems.

31. The system of claim 28, wherein the user interaction data comprises customer service line data comprising inbound voice recognition data or customer service representative data from one or more financial institution systems.

32. The system of claim 28, wherein the user interaction data comprises automated teller machine advertisement response data retrieved from one or more financial institution systems.

33. The system of claim 28, wherein the user interaction data comprises aged referral data, mobile marketing data, sign off splash data, or targeted advertisement data retrieved from one or more financial institution systems.

34. The system of claim 28, wherein the processing device is further configured to:
determine whether the retrieved interaction data is related to the one or more expressions of interest;
determine a rating for the retrieved interaction data, the rating being representative of user feedback regarding the one or more financial products or financial services or one or more related financial products or services; and
if the retrieved interaction data is related to the one or more expressions of interest, calculate the interest index based at least in part on the determined rating.

35. A computer program product comprising a non-transient computer-readable medium comprising computer-executable instructions comprising instructions for:
receiving one or more expressions of interest from a user, the one or more expressions of interest indicating potential interest in one or more financial products or financial services;
calculating an interest index based at least in part on the collected one or more expressions of interest from the user, the interest index configured to quantify a level of interest expressed by the user for one or more financial products or financial services; and
initiating one or more offline marketing efforts for deepening the relationship with the user based on a determined level of engagement.

36. The computer program product of claim 35, wherein the instructions further comprise instructions for:
receiving one or more expressions of interest expressed by the user across one or more online banking channels.

37. The computer program product of claim 35, wherein the instructions further comprise instructions for:
receiving one or more expressions of interest from a user using one or more offline banking channels.

38. The computer program product of claim 35, wherein the instructions further comprise instructions for:
receiving one or more first expressions of interest related to a first product or service;
receiving one or more second expressions of interest related to a second product or service.

39. The computer program product of claim 38, wherein the instructions further comprise instructions for:
calculating the interest index based on the received one or more first expressions of interest and the one or more second expressions of interest.

40. The computer program product of claim 35, wherein the instructions further comprise instructions for:
determining whether a relationship exists between two or more of the expressions of interest; and
setting the interest index at a higher level when a relationship exists between two or more of the expressions of interest than it would be set if no relationship existed between two or more of the expressions of interest.

41. The computer program product of claim 35, wherein the instructions further comprise instructions for:
initiating a direct mailing or email presenting the user with one or more offers for products or services not currently used by the user.

42. The computer program product of claim 35, wherein the instructions further comprise instructions for:
initiating a telephone call to the user for presenting the user with one or more offers for products or services not currently used by the user.

43. The computer program product of claim 35, wherein the instructions further comprise instructions for:
initiating a direct mailing or email presenting the user with one or more offers for modification to one or more products or services currently used by the user.

44. The computer program product of claim 35, wherein the instructions further comprise instructions for:
initiating a telephone call to the user for presenting the user with one or more offers for modification to one or more products or services currently used by the user.

45. The computer program product of claim 35, wherein the instructions further comprise instructions for:
retrieving user interaction data corresponding to the user; and
calculating the interest index is based at least in part on the collected one or more expressions of interest from the user and some or all the retrieved interaction data.

46. The computer program product of claim 45, wherein the user interaction data comprises user transaction data retrieved from one or more financial institution systems.

47. The computer program product of claim 45, wherein the user interaction data comprises online chat data retrieved from one or more financial institution systems.

48. The computer program product of claim 45, wherein the user interaction data comprises customer service line data comprising inbound voice recognition data or customer service representative data from one or more financial institution systems.

49. The computer program product of claim 45, wherein the user interaction data comprises automated teller machine advertisement response data retrieved from one or more financial institution systems.

50. The computer program product of claim 45, wherein the user interaction data comprises aged referral data, mobile marketing data, sign off splash data, or targeted advertisement data retrieved from one or more financial institution systems.

51. The computer program product of claim 45, wherein the instructions further comprise instructions for:
determining whether the retrieved interaction data is related to the one or more expressions of interest;
determining a rating for the retrieved interaction data, the rating being representative of user feedback regarding the one or more financial products or financial services or one or more related financial products or services; and
if the retrieved interaction data is related to the one or more expressions of interest, calculating the interest index based at least in part on the determined rating.
